(19) United States
(12) Patent Application Publication
(10) Pub. No.: US 2025/0375817 A1
(43) Pub. Date: Dec. 11, 2025

(54) Additive Manufacturing Machine Configured to Manufacture an Object from a Printing Powder

(71) Applicant: AddUp, CÉBAZAT (FR)

(72) Inventors: Ali EL OUAZZANI TAYIBI, CÉBAZAT (FR); Ludovic ANGELE, CÉBAZAT (FR)

(21) Appl. No.: 18/877,023

(22) PCT Filed: Jun. 22, 2023
(86) PCT No.: PCT/FR2023/050942

§ 371 Date: Dec. 19, 2024

(30) Foreign Application Priority Data
Jun. 22, 2022 (FR) FR2206147

(51) Int. Cl. B22F 10/28; B22F 10/73; B22F 12/00; B33Y 30/00

(52) U.S. Cl. CPC B22F 10/28; B22F 10/73; B22F 12/38; B33Y 30/00

(57) ABSTRACT

The invention relates to an additive manufacturing machine (4) comprising:-a manufacturing enclosure (49) equipped with a glove box (251):-a powder transport circuit (42):-a power source configured to melt the powder in the manufacturing zone (63); and-a collection circuit (57) configured to collect powder from the transport circuit (42) and transport the collected powder to an outlet of the collection circuit (57), the outlet of the collection circuit being located above a reception zone (281), the reception zone (281) being different from the manufacturing zone (63) and located opposite the outlet of the collection circuit (57), and the gloves (251) being configured to handle an object located in the enclosure (49) and to reach the reception zone (281).

### FIELD OF THE INVENTION

The present invention relates to the general field of additive manufacturing machines and more particularly to the field of unloading and loading of powder in additive manufacturing machines.

### STATE OF THE ART

Selective additive manufacturing consists in producing three-dimensional objects by consolidation of selected zones on successive layers of additive manufacturing powder (metal powder, ceramic powder, etc.).

Conventionally, an additive manufacturing device comprises a supply and storage module in which the powder is prepared, and in particular screened, and then reserved in a buffer hopper before its use. The device also comprises a manufacturing machine connected to the supply and storage module. The powder is transferred from the buffer hopper to the manufacturing machine where it is spread as a layer and then consolidated to make a three-dimensional object.

Once the object is manufactured, powder that has been spread but not consolidated may be recycled to the buffer hopper for further use.

When the additive manufacturing powder has been too recycled to be used or when the user wishes to change batches of powder, it is necessary to discharge the powder contained in the additive manufacturing device.

To avoid any contact of the operator with the powder and to secure the operation in the case of powders with a low minimum ignition energy (a term also known by the abbreviation EMI), an auxiliary device is conventionally used which is specifically dedicated to discharge into an inert atmosphere, for example a glove box.

However, such an auxiliary device occupies a large space.

### DESCRIPTION OF THE INVENTION

An object of the invention is to propose an additive manufacturing device that is less bulky than in the prior art.

The object is achieved in the context of the present invention by means of an additive manufacturing machine comprising:
a manufacturing enclosure configured to be sealed and equipped with a glove box with gloves,
a circuit for transporting manufacturing powder to a device for depositing layers of powder, the device for depositing layers of powder being configured to spread the powder over a manufacturing zone in the manufacturing enclosure, the device for depositing layers of powder comprising a powder receiving surface and a powder inlet, the powder inlet being located above the powder receiving surface,
power source configured to selectively melt the production powder spread in the production zone, and
a sampling circuit configured to sample powder from the transport circuit and transport the sampled powder to an output of the sampling circuit, the output of the sampling circuit being located above a reception zone,
the outlet of the sampling circuit and the receiving zone located in the manufacturing enclosure, the receiving zone being different from the manufacturing zone and located opposite the outlet of the sampling circuit, the gloves being configured to handle an object located in the enclosure and reach the receiving zone when the enclosure is closed.

The sampling circuit defines a possible route for extracting powder from the device and filling containers placed in the additive manufacturing chamber. The gloves in the enclosure's glove box perform two functions: they can handle the object once it is manufactured and they can poach the powder in containers. It is then no longer necessary to use an auxiliary device dedicated specifically to the unloading of powder. In this situation, the problem of reducing the bulk of the additive manufacturing device is solved. Such a machine also allows a lower manufacturing and maintenance cost.

Such a machine is advantageously and optionally supplemented by the following various characteristics taken alone or in combination:
the sampling circuit is configured to sample powder from a part of the transport circuit outside the enclosure;
the receiving area and the sampling circuit outlet are fixed with respect to the enclosure;
the powder receiving surface of the powder layer deposition device is movably mounted relative to the manufacturing area;
the sampling circuit comprises a coupling configured to isolate the sampling circuit from the enclosure and a receptacle received in the receiving area so that the powder flows in a sealed manner from the sampling circuit to the receptacle;
the connector is configured to slide along a conduit defining an outlet of the sampling circuit and to contact edges of the received container in the receiving area;
the sampling circuit comprises a vent configured to balance a pressure inside the sampling circuit with a pressure outside the sampling circuit when the connector isolates the inside of the sampling circuit and the inside of the container from the enclosure;-a sensor configured to detect a level of powder filling of a container when the container is received in the receiving area;
a suction rod configured to suck up powder located in the receiving area and powder located in the manufacturing area;

The invention also relates to an additive manufacturing installation comprising a machine as just described, the installation further comprising a powder supply module configured to prepare, sieve and preserve powder, an output of the supply module being connected to an input of the transport circuit.

Such an installation is advantageously and optionally supplemented by the following characteristics: the sampling circuit comprises a connector configured to isolate the sampling circuit from the enclosure and a container received in the reception zone so that the powder flows in a sealed manner from the sampling circuit to the container. The connector is configured to slide along a conduit defining an outlet of the sampling circuit and to come into contact with edges of the container received in the reception zone, the suction rod being connected to an inlet of the supply module.

The invention further relates to a method for repotting manufacturing powder in an additive manufacturing machine comprising a manufacturing enclosure, the machine being configured to manufacture an object from the powder in a manufacturing area of the enclosure, the enclosure being equipped with a glove box with gloves, the gloves being configured to handle the object from outside the enclosure, the method comprising the steps, the enclosure being closed, of:
taking powder from a transport circuit so as to place the taken powder in a container received in a reception zone of the enclosure, the reception zone being different from the manufacturing zone, and
close the container with gloves from outside the enclosure, the container not being part of the machine and being configured to be removed from the enclosure.

Such a re-potting process is advantageously and optionally supplemented by the following various characteristics taken alone or in combination: a step prior to the step of removing the powder, the step consisting in moving a coupling to isolate, with respect to the enclosure, a powder-removal circuit and the container, a step of positioning a sensor configured to detect a powder filling level of the container so as to define a filling level of the container;

Finally, the invention relates to a method for loading manufacturing powder into an additive manufacturing machine comprising a manufacturing enclosure, the machine being configured to manufacture an object from the powder in a manufacturing area of the enclosure, the enclosure comprising a glove box with gloves, the gloves being configured to handle the object from outside the enclosure, the method comprising the steps of:-inserting into the enclosure a container filled with powder and hermetically sealed, the container being received in a receiving area, the receiving area being different from the manufacturing area, sealing the enclosure,
with the enclosure closed, open the container with gloves from outside the enclosure, and
with the enclosure closed, draw up the powder from the container so as to transfer it to a powder supply module configured to prepare, sieve and store powder.

### DESCRIPTION OF THE FIGURES

Other characteristics and advantages of the invention will emerge from the following description, which is purely illustrative and non-limiting, and must be read with reference to the appended drawings in which:

FIG. 1 is a schematic representation of an additive manufacturing device according to an embodiment of the invention.

FIGS. 2 to 5 are schematic representations of details of the additive manufacturing device illustrated in FIG. 1.

FIG. 6 is a schematic representation of a method for loading additive manufacturing powder according to an embodiment of the invention.

FIG. 7 is a schematic representation of a method for repotting additive manufacturing powder according to an embodiment of the invention.

### DETAILED DESCRIPTION OF THE INVENTION

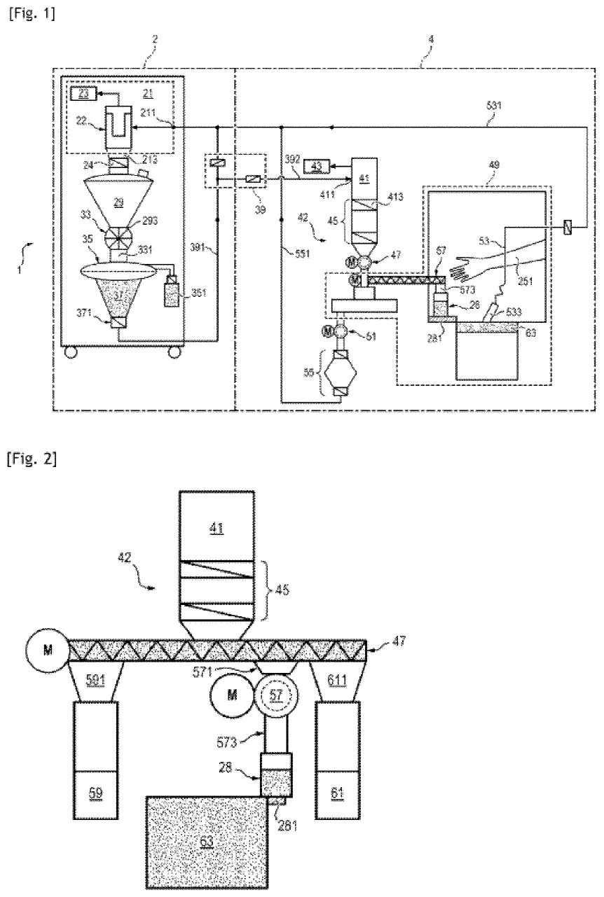

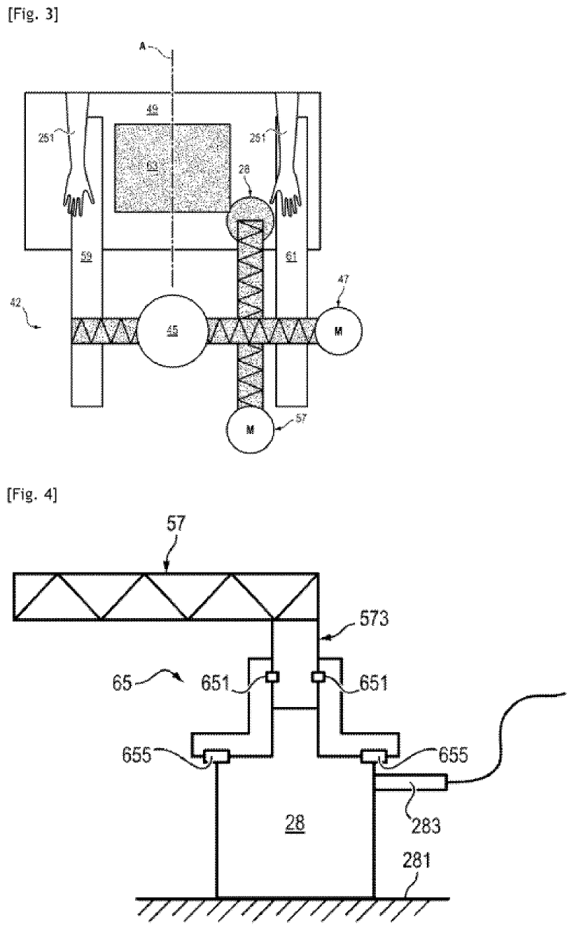

With reference to FIGS. 1 to 5, an additive manufacturing device 1 is presented comprising a manufacturing machine 4 and a powder supply module 2.

### Manufacturing Machine

The manufacturing machine 4 is configured to implement additive manufacturing of objects from a printing powder or manufacturing powder.

This manufacture consists in producing three-dimensional objects by consolidation of selected zones on successive layers of pulverulent material (metal powder, ceramic powder, etc.). The consolidated zones correspond to successive sections of the three-dimensional object. Consolidation is carried out, for example, layer by layer, by a total or partial selective melting carried out with a power source.

In particular, high-power laser sources or electron beam sources may be used as power sources for melting powder layers.

The manufacturing machine comprises an enclosure 49 in which the manufacturing takes place. More precisely, the manufacture takes place in a manufacturing zone 63 (or printing zone) situated in the enclosure 49.

The powder is initially located in a part outside the chamber 49, and preferably above the printing zone 63.

For example, the manufacturing machine may comprise, preferably in its upper part, a suction system 41 connected to a gas evacuation circuit 43. The suction system 41 has an inlet 411 connected to the powder supply module 2. The suction system 41 is adapted to generate a suction force at the inlet 411 directed towards the inside of the suction system 41. The inlet 411 of the suction system 41 is connected to a manufacturing duct 392 which can connect the manufacturing machine to the outlet of the preparation module 2. The gas discharge circuit 43 may comprise a vacuum pump for generating the suction force. The suction system 41 may comprise a powder filter so that the powder does not pass into the gas discharge circuit 43. The suction system 41 comprises a device which makes it possible to separate the powder from the gas, such as, for example, a cyclone. Other devices exist to separate the powder from the gas, such as a filter box comprising filters, a cyclofilter or a discharge box. The suction system 41 is adapted to receive and store additive manufacturing powder from the inlet 411. The preserved powder is located at the bottom of the second suction system 41 and can be extracted via the outlet 413.

Alternatively, the manufacturing machine may comprise a fixed reservoir of powder, for example a buffer reservoir, in addition to or in place of the suction system 41.

The fixed reservoir of powder when it is present or the suction system 41 have an outlet 413 situated in their lower part.

### Transport Circuit

The manufacturing machine 4 comprises a transport circuit 42 configured to convey powder from the suction system 41 or from the fixed reservoir to a powder layer deposition device.

The transport circuit 42 may comprise an airlock 45 connected to the outlet 413 of the suction system 41 or of the fixed reservoir. The airlock 45 makes it possible to transmit powder without the enclosure 49 being never in communication with the fixed reservoir or the suction system 41. This avoids disturbing inerting and pressure in the printing chamber. According to a first embodiment illustrated in FIG. 1, the transport circuit 42 comprises a divergent screw 47 downstream of the lock chamber 45 if necessary.

In a first preferred variant, the device for depositing layers comprises at least one fixed powder inlet and at least one movable powder receiving surface moving under this fixed powder inlet.

The device for depositing layers of powder also makes it possible to spread the powder from the movable powder-receiving surface towards the manufacturing zone 63 of the object in the enclosure 49.

It is in the manufacturing zone 63 that the objects are produced by selective consolidation of the powder obtained with the power source.

In this first variant, the layer deposition device preferably comprises a left hopper 591 and a right hopper 611. The diverging screw 47 is configured to fill the left hopper 591 and the right hopper 611. The left hopper is situated on a first side of the manufacturing zone 63, and the right hopper is situated on a second side of the manufacturing zone 63, the second side being opposite the first side with respect to a horizontal axis A passing through the manufacturing zone 63

The layer deposition device comprises, in correspondence with each hopper 591 and 611, a metering device which is supplied by the hopper. Below each doser runs a movable powder-receiving surface of the layer deposition device.

Each metering device forms a fixed inlet of powder as described above.

Each slide 59, 61 defines a movable powder-receiving surface as described above.

Each slide 59, 61 is configured to move in a translational movement parallel to the horizontal axis A. When a metering device delivers a flow of powder to the slide which moves under this metering device, a continuous cord of powder is formed on the upper surface of this slide. Simultaneously with its movement under a metering device, each slide enters the enclosure 49 so as to place the cord of powder that it transports opposite the manufacturing zone 63.

In a second variant, a device for depositing layers of powder may comprise at least one movable powder inlet in the enclosure 49 and at least one fixed powder receiving surface in the enclosure 49.

In either of these variants, the powder layer deposition device comprises a roller or a scraper, both configured to spread the powder placed on the powder receiving surface over the manufacturing area 63.

### Enclosure

The three-dimensional objects are manufactured in the enclosure 49. The enclosure 49 constitutes a manufacturing enclosure. The enclosure 49 is suitable for being closed in leaktight manner. The enclosure 49 comprises a door on one of its sidewalls which can be closed in leaktight manner or alternatively be opened to give access to an operator inside the enclosure. In particular, the operator can extract the object manufactured by additive manufacturing into the enclosure by means of the door.

The enclosure 49 preferably comprises a glove box. The glove box is integrated into a wall and gloves 251 are fixed in a sealed manner to this wall. The gloves 251 are flexible so that an operator can handle parts located inside the enclosure 49 when the latter is closed. In particular, the gloves 251 are placed and configured in such a way that an operator can access a manufacturing zone 63 of the object and manipulate the object manufactured or in the course of manufacture.

### Sampling Circuit

The manufacturing machine 4 comprises a sampling circuit 57 configured to sample powder from the transport circuit 42.

The sampling circuit 57 constitutes an additional circuit with respect to the transport circuit.

The transport circuit and the sampling circuit 57 each comprise an opening facing each other so that powder can be transferred from the transport circuit to the sampling circuit 57. A pipe can join the two openings to guide the powder from the transport circuit to the sampling circuit 57.

The opening in the transport circuit can be controlled to be closed or opened to prevent or allow the transfer of powder from the transport circuit to the sampling circuit 57.

The sampling circuit 57 is configured to move powder from the opening of the sampling circuit 57 to an outlet of the sampling circuit 573, called the discharge outlet, located in the enclosure 49. The opening of the sampling circuit thus constitutes the input of the sampling circuit.

The opening of the sampling circuit can be placed outside the enclosure 49 so that the sampling circuit 57 is configured to sample powder from a part of the transport circuit 42 located outside the enclosure 49.

In the case where a part of the transport circuit 42 is situated in the enclosure 49, the opening of the sampling circuit can be placed inside the enclosure 49.

The transfer of powder from the transport circuit to the sampling circuit 57 can be carried out in a vertical plane or in a plane having a non-zero slope with respect to the horizontal plane.

The sampling circuit 57 for transporting the powder may comprise a divergent screw, a single screw or a vibrating chute.

In addition, the sampling circuit 57 may comprise a powder metering device for controlling the quantity or the flow rate of powder which is transported in the sampling circuit and delivered via the discharge outlet 573. The discharge outlet 573 of the sampling circuit 57 is located inside the enclosure 49. More precisely, the discharge outlet 573 of the sampling circuit is situated above a reception zone 281 situated in the enclosure 49. The receiving zone 281 is configured to receive a container 28 so that the upper edge of the container is located below the discharge outlet 573 of the sampling circuit. The container 28 is not part of the machine and is configured to be introduced into or removed from the enclosure 49 by an operator. The container 28 is intended to contain printing powder. The reception area 281 is also configured to be accessible by the gloves. In other words, an operator can move, open and/or close a container located in the reception area 281.

Advantageously, the reception area 281 and the output of the sampling circuit 57 are fixed with respect to the enclosure 49.

The manufacturing machine 4 may optionally comprise a sensor 283 configured to detect a level of powder filling of the container 28 when the container 28 is received in the reception zone 281. The sensor is located in the reception zone 281 or close to this zone. The sensor is movable so that an operator can adjust the position of the sensor. By adjusting the position of the sensor 283 to a greater or lesser extent facing the container 28, the operator can define the desired level of filling.

The sensor 283 may be of the magnetic capacitive or inductive type, in particular when the powder is metallic. Other types of sensor can be used to produce a signal whose value changes when the powder level in the pot reaches the level of the detector.

When the sampling circuit 57 comprises a powder metering device and a sensor, they can be connected to each other in particular so that the sensor sends a “filled container” signal to the metering device which then stops the transport of powder in the sampling circuit.

The receiving zone 281 may advantageously be directly adjacent to the manufacturing zone 63. In this way, the operator can, by virtue of the gloves 251 configured to access the manufacturing zone, recover the manufactured part or handle a suction rod 53, also access the reception zone 281. The gloves 251 are therefore configured to allow the manipulation of an object in the manufacturing zone and access to the reception zone 281.

### Sealing Connector

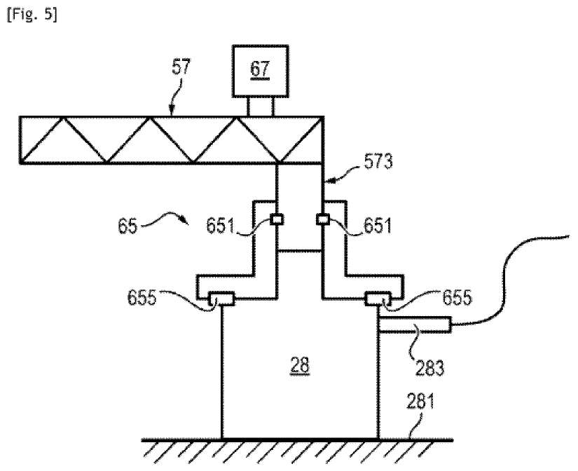

Optionally and with reference to FIGS. 4 and 5, the sampling circuit 57 may comprise a connector 65 configured to isolate the sampling circuit 57 and the receptacle 28 received in the reception zone from the enclosure 49 so that the powder flows in leaktight manner from the sampling circuit to the receptacle.

In the presence of a container 28 located below the discharge outlet 573, the connector 65 can be brought simultaneously into contact with the discharge outlet 573 and the container 28. In this way, the powder extraction circuit is connected in a sealed manner to the inside of the container. The powder thus flows from the sampling circuit into the container without generating a cloud of powder in the printing chamber. This avoids pollution of the enclosure and in particular of the optical units contained therein.

More precisely, the connector 65 can be configured to slide along a conduit defining the discharge outlet and come into contact with edges of the receptacle 28 received in the reception area 281. In particular, the duct may be oriented in a vertical direction so that the seal 65 slides in the vertical direction. In the presence of a receptacle 28 located below the discharge outlet 573, the connector 65 may:
be placed in the closed configuration by being lowered along the conduit until coming into contact with the upper edge of the container 28, o
be placed in the open configuration by being raised along the conduit until no longer in contact with the upper edge of the container 28.

By maintaining sufficient pressure of the coupling against the upper edge of the container in the closed configuration, the necessary sealing is achieved.

A deformable seal 651 may be provided between the coupling 65 and the conduit defining the discharge outlet.

A deformable seal 655 may be provided between the coupling 65 and the upper edge of the container 28.

In a variant and with reference to FIG. 5, the sampling circuit further comprises a vent 67 configured to balance a pressure inside the sampling circuit with a pressure outside the sampling circuit when the connector 65 isolates the inside of the sampling circuit and the inside of the container.

The vent 67 is located upstream of the discharge outlet 573. The vent notably comprises a filter arranged between the internal volume of the sampling circuit and the enclosure 49. The vent 67 makes it possible to prevent a cloud of powder from forming at the level of the container 28 when the connector 65 is withdrawn.

### Powder Recovery System

Optionally, the manufacturing machine 4 may comprise a system for recovering the spread and unconsolidated powder at the end of manufacture

The recovery system may comprise a suction pipe 53 configured to aspirate powder.

The suction pipe 53 comprises a suction nozzle 533 which constitutes the inlet of the suction pipe. The gloves 251 are configured in this option so that an operator can manipulate the suction rod 53. The operator can thus place the suction nozzle 533 in different places of the enclosure 49 and aspirate the powder which is located in these different places.

The powder is sucked up at the level of the spout 533 and transmitted to the other end of the rod which constitutes the outlet of the suction rod 53. The manufacturing device 1 may comprise a first recovery duct 531 connected to the outlet of the suction pipe 53.

With reference to FIG. 1, the recovery system may also comprise an airlock 55 adapted to recover the excess powder deposited on the manufacturing zone 63.

The manufacturing device 1 may comprise a second recovery pipe 551 connected to the lock chamber exceeding 55.

The lock chamber exceeding 55 makes it possible to transmit powder without the printer chamber ever being in communication with the second recovery duct 551 in order to avoid disturbing the printing chamber with respect to inerting and pressure.

The invention also covers an additive manufacturing device comprising a manufacturing machine as just described and a powder supply module configured to prepare, sieve and preserve powder, an output of the supply module being connected to an input of the transport circuit

### Supply Module

The supply module 2 comprises in its upper part a second suction system 21 connected to a first gas evacuation circuit 23. The second suction system 21 is distinct from the first suction system 41 mentioned above. The second suction system 21 has an inlet 211 and an outlet 213 located at the bottom of the second suction system 21. The second suction system 21 is adapted to generate a suction force at the inlet 211 directed towards the inside of the second suction system 21. The first gas discharge circuit 23 may comprise a vacuum pump for generating the suction force. The second suction system 21 is adapted to receive additive manufacturing powder from the inlet 211 and to store it. The preserved powder is located at the bottom of the second suction system 21 and can be extracted via the outlet 213. The second suction system 21 may comprise a powder filter so that the powder does not pass into the first discharge circuit 23. The suction system 21 comprises a device which makes it possible to separate the powder from the gas, such as, for example, a cyclofilter 22. Other devices exist to separate the powder with gas such as a filter box including filters, a cyclone or a discharge box

The supply module 2 comprises a main hopper 29 which is situated below the second suction system 21. The main hopper 29 is a container which makes it possible to preserve additive manufacturing powder.

The supply module 2 comprises a valve 24 located between the second suction system 21 and the main hopper 29. The valve 24 in the open configuration allows powder to pass through and the valve 24 in the closed configuration allows the second suction system 21 to be separated in leaktight manner from the main hopper 29. The main hopper 29 has a volume of frustoconical shape adapted to preserve a large quantity of manufacturing powder. The main hopper 29 is oriented in such a way that the axis of the frustoconical shape is vertical and that the volume of the frustoconical shape has a smaller horizontal section at the bottom of the hopper. The main hopper 29 has an outlet 293 located at the bottom of the main hopper.

The supply module 2 comprises a metering device 33, located below the main hopper 29. The metering device 33 makes it possible to adjust the flow rate of powder sent downstream. The metering device 33 is connected to the outlet 293 of the main hopper. The metering device 33 has an outlet 331 located at the bottom of the metering device 33.

The supply module 2 comprises a sieve 35, located below the metering device 33. The sieve 35 is connected to the outlet 331 of the metering device 33.

The metering device 33 makes it possible to adjust the flow rate of powder sent to the sieve 35, so as not to degrade a sieve included inside the sieve 35.

The sifter serves to filter the agglomerated clusters of powder and to isolate them from the rest of the powder within a receptacle 351.

The supply module 2 comprises a tank 37 located below the sieve 35. The reservoir 37 may be a hopper having a volume of frustoconical shape suitable for preserving a large quantity of manufacturing powder. This hopper can be oriented so that the axis of the frustoconical shape is vertical and the volume of the frustoconical shape has a smaller horizontal section at the bottom of the hopper. The reservoir 37 has an outlet 371 situated at the bottom of the reservoir.

The outlet 371 of the tank is connected to a return circuit 391. The return circuit 391 connects the outlet 371 of the reservoir 37 and the inlet 211 of the suction system 21. The second suction system 21 can suck the powder from the reservoir 37 to the second suction system 21 through the return circuit 391.

The outlet 371 of the tank is also connected to a manufacturing duct 392. The manufacturing duct 392 connects the outlet 371 of the reservoir 37 and the manufacturing machine 4, so that powder contained in the reservoir 37 can be transferred to the manufacturing machine 4.

The sieve 35 is located just above the reservoir 37 so that the powder contained in the reservoir 37 and transmitted to the manufacturing machine 4 is sieved as late as possible before it is sent to the manufacturing machine 4.

The tank 37 may have a smaller volume than the main hopper 29. The role of the reservoir 37 is to preserve the powder just before it is transported either to the manufacturing machine 4 or to the second suction system 21. The tank 37 can be described as a buffer hopper.

The main hopper 29 is adapted to contain a large part of the manufacturing powder necessary for the additive manufacture of one or more three-dimensional objects. The powder contained in the main hopper 29 is intended to be transmitted to the manufacturing machine 4. To this end, the main hopper 29 is adapted to be connected to the manufacturing machine 4 configured to additionally manufacture an object on the basis of the powder located in the main hopper 29. The connection of the main hopper 29 to the manufacturing machine is achieved by the circulation of powder passing through the metering device 33, the sieve 35, the reservoir or buffer hopper 37 and finally the manufacturing conduit 392.

The supply module 2 comprises a controller which makes it possible to route the powder from the outlet 371 to the return circuit 391 or to the manufacturing conduit 392.

The supply module 2 comprises a circulation system comprising the suction system 21.

The second suction system 21 can suck the powder from the reservoir 37 to the second suction system 21 through the return circuit 391.

The first recovery duct 531 connects the outlet of the suction pipe 53 and the inlet 211 of the second suction system 21.

The second recovery duct 551 connects the lock chamber exceeding 55 and the inlet 211 of the second suction system 21.

The manufacturing device 1 can also comprise a controller adapted to circulate the powder in a controlled manner from the recovery system to a suction system of the supply module. Such a controller makes it possible to route the powder from the first recovery duct 531 or from the second recovery duct 551 to the supply module.

The input 211 can be qualified as an input of the supply module 2 adapted to be connected to the manufacturing machine 4 and to receive powder located in the manufacturing machine 4.

It should be noted that the manufacturing device 1 comprises sufficient valves at the crossings of ducts 391, 392, 531 and 551 to allow or prevent the powder circulations mentioned in the description.

### Loading Method

The invention relates to a method for loading manufacturing powder into a manufacturing enclosure 49 configured to manufacture an object from the powder in a manufacturing zone 63 of the enclosure 49, the enclosure 49 being equipped with a glove box with gloves 251 configured to handle the object from outside the enclosure, the method comprising the steps of:
inserting into the enclosure 49 a container 28 filled with powder and hermetically sealed, the container 28 being received in a receiving zone 281, the receiving zone (281) being different from the manufacturing zone 63,
seal the enclosure,
with enclosure 49 closed, open container 28 by means of gloves 251 from outside enclosure 49 and
with the enclosure 49 closed, aspirate the powder contained in the container 28 so as to transfer it to a powder supply module 2 configured to prepare, sieve and store powder. It should be noted that the additive manufacturing machine has been described above and comprises the circuit 42 for transporting manufacturing powder to a device for depositing layers of powder, the device for depositing layers of powder being configured to spread the powder over the manufacturing zone 63, the device for depositing layers of powder comprising a powder receiving surface and a powder inlet, the powder inlet being situated above the powder receiving surface.

In this method, the enclosure 49 is configured to manufacture an object from the powder inside the enclosure 49, the gloves being configured to manipulate the object inside the enclosure 49 from outside the enclosure 49, the supply module being configured to prepare, sieve and store powder.

In this way, it is possible to load powder into the supply module through the enclosure in which the manufacture takes place. It is therefore no longer necessary to have an external enclosure specifically dedicated to the loading of the supply module: the overall size of the device is thus reduced

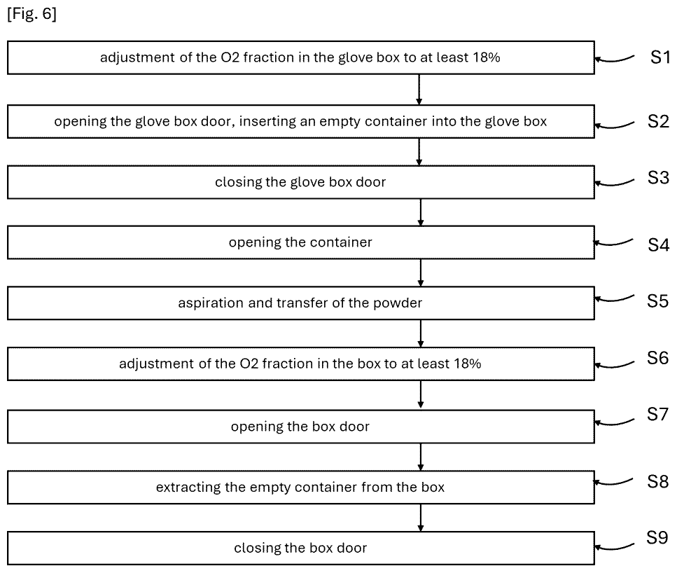

The device 1 as described above comprising the manufacturing machine 4 and the supply module 2, the first recovery duct 531 connecting the outlet of the suction pipe 53 and the inlet 211 of the second suction system 21, allows the loading of the manufacturing powder according to these steps, and more broadly according to the steps described below, repeated in FIG. 6.

Initially, the chamber 49 is hermetically sealed and does not contain any receptacles.

During a first step S1, the oxygen fraction inside the chamber 49 is adjusted to reach at least 18%. In particular, an oxygen sensor may acquire a measurement of the oxygen fraction for this purpose.

During a second step S2, the door of the enclosure 49 is opened and a container 28 of powder is inserted or several containers of powder are inserted therein, for example they are placed on the reception area 281.

During a third step S3, the chamber 49 is sealed and the oxygen fraction is adjusted to at most 2% therein.

In a fourth step S4, the operator manipulates the container 28 and opens it by means of the gloves 251 from outside the box 49.

During a fifth step S5, the operator manipulates a suction rod 53 by means of gloves 251 from outside the box 49 to aspirate the powder contained in the container, the powder then being transferred to the supply module 2.

If more than one container of powder has been inserted, steps S4 to S5 are repeated until all the inserted containers are empty.

During the sixth step S6, the oxygen fraction inside the housing is adjusted to reach at least 18%.

During a seventh step S7, the door of the enclosure 49 is opened. During an eighth step S8, the filled and closed container or the filled and closed containers are extracted from the chamber 49.

During a ninth step S9, the door of the enclosure 49 is hermetically closed.

Once reached the supply module 2, the powder can be screened and stored in the reservoir 37. The powder contained in the main hopper 29 is transmitted to the sieve 35 through the metering device 33. The sifter 35 sieves the powder and extracts the powder clusters and the powder aggregates that are too large. These clusters are transmitted to the receptacle 351 and are kept in the receptacle. The sieved powder passes through the sieve 35 and passes into the reservoir 37 in which it is stored before use.

### Method of Repotting

The invention relates to a method for repotting manufacturing powder in an additive manufacturing machine comprising a manufacturing enclosure 49, the machine being configured to manufacture an object from the powder in a manufacturing zone 63 of the enclosure 49, the enclosure 49 being equipped with a glove box with gloves 251, the gloves 251 being configured to handle the object from outside the enclosure 49, the method comprising the steps, the enclosure 49 being closed, consisting of:
taking powder from a transport circuit 42 so as to place the powder taken from a receptacle 28 received in a reception zone 281 of the enclosure 49, the reception zone 281 being different from the manufacturing zone 63, and
closing the container 28 by means of the gloves 251 from outside the enclosure 49), the container 28 not being part of the machine and being configured to be extracted from the enclosure 49.

It should be noted that the additive manufacturing machine has been described above and comprises the circuit 42 for transporting manufacturing powder to a device for depositing layers of powder, the device for depositing layers of powder being configured to spread the powder over the manufacturing zone 63, the device for depositing layers of powder comprising a powder receiving surface and a powder inlet, the powder inlet being situated above the powder receiving surface.

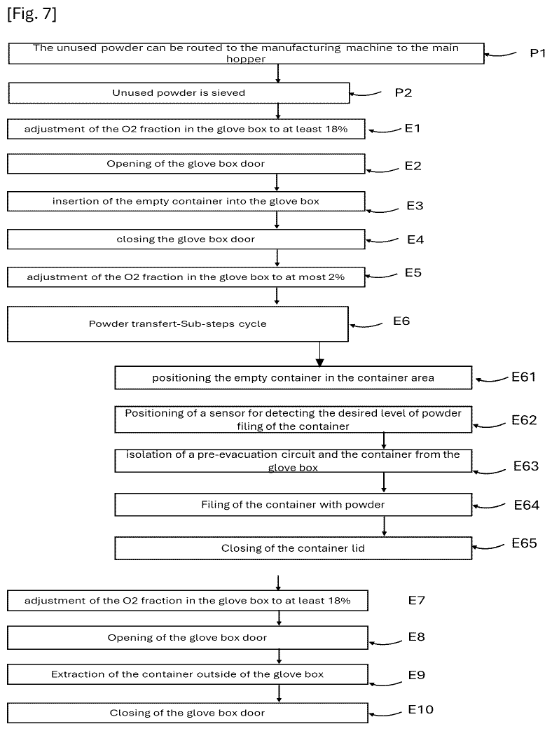

The manufacturing machine 4 thus allows the unused manufacturing powder to be repotted according to these steps, and more generally according to the steps described below, repeated in FIG. 7.

The unused powder may initially be located in the reservoir 37 of the supply module 2 and be conveyed to the manufacturing machine 4. Initially, the chamber 49 is hermetically sealed and does not contain any receptacles.

During a first step E 1, the oxygen fraction inside the chamber 49 is adjusted to reach at least 18%.

During a second step E 2, the door of the enclosure 49 is opened. During a third step E 3, an empty container is inserted or several empty containers are inserted into the enclosure 49. The receptacles may be placed in the reception zone 281. The lids of the containers are also inserted. The containers may be entered open. Containers may be closed in particular if they contain an inert atmosphere, i.e. with a gaseous composition of at most 2% oxygen and at least 98% inert gas.

In a fourth step E 4, the door of the enclosure 49 is hermetically closed.

During a fifth step E 5, the oxygen fraction in the chamber 49 is adjusted to at most 2%.

During a sixth step E 6, a loop of sub-steps is performed.

During a first sub-step E 61, an empty container is placed in the receiving zone 281 under the discharge outlet 573.

During a second sub-step E 62, the operator positions a sensor 283 configured to detect a level of powder filling of the container so as to define a desired level of filling of the container.

In a third sub-step E 63, the coupling 65 is moved to isolate the sampling circuit 57 and the receptacle 28 received in the reception zone 281 from an enclosure of the box 49.

In a fourth sub-step E 64, the sampling circuit is actuated to sample powder above a manufacturing zone and thus to discharge a quantity of powder towards the outlet of the sampling circuit. This quantity is less than or equal to a maximum capacity of the container. A metering device of the sampling circuit may receive a signal from the sensor to terminate filling when the sensor emits a “filled container” signal.

In a fifth sub-step E 65, the container and its lid are handled using the gloves 251 so as to close the container with the lid. The operator closes the container with the lid.

The sub-step loop is resumed as long as there is an empty container and powder to be re-potted. That is, when there is no empty container or powder to poke, the sub-step loop is broken. In this case, a seventh step E 7 is carried out.

During the seventh step E 7, the oxygen fraction inside the housing is adjusted to reach at least 18%.

During an eighth step E 8, the door of the enclosure 49 is opened.

During a ninth step E 9, the filled and closed container or the filled and closed containers are removed from the chamber 49.

During a tenth step E 10, the door of the enclosure 49 is hermetically closed.

It should be noted that the sub-steps E 62 and E 63 are optional and are advantageously carried out when the manufacturing machine comprises respectively a sensor 283 and a coupling 65. It should also be noted that this powder can be remounted before re-potting. Regardless of the position of the powder to be pooled in the device, it is possible to transport the powder via the second suction system 21 to the main hopper 29 (step P 1). This unused powder can then be re-sieved by the sieve 35. Thereafter, the unused and remasted powder is returned to the manufacturing machine and a container placed in the reception area. It is thus possible to repackage powder under a protective atmosphere in quantities that can be transported by an operator before storing it for possible subsequent reuse.

1. An additive manufacturing machine comprising:
a manufacturing enclosure configured to be sealed and equipped with a glove box with gloves,
a transport circuit for transporting a manufacturing powder to a device for depositing layers of powder, the device for depositing layers of powder being configured to spread the powder over a manufacturing zone in the manufacturing enclosure, the device for depositing layers of powder comprising a powder receiving surface and a powder inlet, the powder inlet being located above the powder receiving surface,
a power source configured to selectively melt the manufacturing powder spread in the manufacturing zone, and
a sampling circuit configured to sample powder from the transport circuit and transport the sampled powder to an outlet of the sampling circuit, the outlet of the sampling circuit being located above a reception zone,
the outlet of the sampling circuit and the receiving zone being located in the manufacturing enclosure, the receiving zone being different from the manufacturing zone and located opposite the outlet of the sampling circuit, the gloves being configured to handle an object located in the manufacturing enclosure and reach the receiving zone when the enclosure is closed.

2. The additive manufacturing machine of claim 1, wherein the sampling circuit is configured to sample powder from a part of the transport circuit situated outside the manufacturing enclosure.

3. The additive manufacturing machine of claim 1, wherein the reception area and the outlet of the sampling circuit are fixed with respect to the enclosure.

4. The additive manufacturing machine of claim 1, wherein the powder-receiving surface of the powder layer deposition device is mounted so as to be movable with respect to the manufacturing zone.

5. The additive manufacturing machine of claim 1, wherein the sampling circuit comprises a connection configured to isolate the sampling circuit from the manufacturing enclosure and a container received in the reception zone so that the powder flows in a sealed manner from the sampling circuit to the container.

6. The additive manufacturing machine of claim 5, where, in the coupling is configured to slide along a conduit defining an outlet of the sampling circuit and to come into contact with edges of the container received in the reception zone.

7. The additive manufacturing machine of claim 5, where, in the sampling circuit comprises a vent configured to balance a pressure inside the sampling circuit with a pressure outside the sampling circuit when the connector isolates the inside of the sampling circuit and the inside of the container from the enclosure.

8. The additive manufacturing machine of claim 1, further comprising a sensor configured to detect a level of powder filling of a container when the container is received in the reception zone.

9. The additive manufacturing machine of claim 1, further comprising a suction rod configured to suck up powder situated in the reception zone and powder situated in the manufacturing zone.

10. An additive manufacturing installation comprising the machine of claim 1, the device further comprising a powder supply module configured to prepare, sieve and preserve powder, an output of the supply module being connected to an input of the transport circuit.

11. The additive manufacturing installation of claim 10, the additive manufacturing machine being in accordance with claim 6, the suction rod being connected to an inlet of the supply module.

12. A method of repotting manufacturing powder in an additive manufacturing machine comprising a manufacturing enclosure, the machine being configured to manufacture an object from the powder in a manufacturing zone of the manufacturing enclosure, the manufacturing enclosure being equipped with a glove box with gloves, the gloves being configured to handle the object from outside the enclosure, the method comprising the steps, the enclosure being closed, comprising:
removing powder from a transport circuit so as to place the removed powder in a container received in a reception zone of the manufacturing enclosure, the reception zone being different from the manufacturing zone, and
close the container by means of gloves from outside the manufacturing enclosure, the container not being part of the machine and being configured to be removed from the manufacturing enclosure.

13. The method of re potting manufacturing powder of claim 12, comprising a step prior to the step of sampling the powder consisting of moving a connection in order to insulate, with respect to the manufacturing enclosure, a powder sampling circuit and the container.

14. The method of repotting manufacturing powder of claim 12, further comprising a step of positioning a sensor configured to detect a level of filling of the container with powder so as to define a level of filling of the container.

15. A method of loading manufacturing powder into an additive manufacturing machine comprising a manufacturing enclosure, the machine being configured to manufacture an object from the powder in a manufacturing zone of the manufacturing enclosure, the manufacturing enclosure comprising a glove box with gloves, the gloves being configured to handle the object from outside the box, the method comprising the steps of:
insert into the enclosure a container filled with powder and hermetically sealed, the container being received in a reception zone, the reception zone being different from the manufacturing zone,
seal the enclosure,
with enclosure closed, open the container with the gloves from outside of the manufacturing enclosure, and
with the enclosure closed, suck up the powder contained in the container so as to transfer it to a powder supply module configured to prepare, sieve and store powder.
